(19) United States
(12) Patent Application Publication
(10) Pub. No.: US 2010/0288423 A1
(43) Pub. Date: Nov. 18, 2010

(54) PROCESS FOR MANUFACTURING TYRES FOR VEHICLE WHEELS

(75) Inventors: Maurizio Marchini, Milano (IT); Fiorenzo Mariani, Milano (IT); Riccardo Azzaretto, Milano (IT); Stefano Sangiovanni, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI TYRE S.p.A., Milano (IT)

(21) Appl. No.: 12/308,466

(22) PCT Filed: Jun. 29, 2006
(86) PCT No.: PCT/IB2006/001783

§ 371 Date: Aug. 4, 2010

(51) Int. Cl. B29D 30/08; B32B 37/00; B32B 38/04

(52) U.S. Cl. 156/123; 156/394.1; 156/397

(57) ABSTRACT

In a process for manufacturing tyres for vehicle wheels, including building, on a toroidal support, a carcass structure including at least one carcass ply associated, at axially opposite end edges thereof, with annular anchoring structures, the step of building the carcass structure includes forming at least one reinforcing structure, operatively associated with the annular anchoring structures through deposition on the toroidal support of at least one reinforcing element at a deposition region defined on the toroidal support. The deposition of the at least one reinforcing element includes the steps of providing at least one reinforcing element having a length determined as a function of the length of the deposition region; deforming the at least one reinforcing element to form an annular reinforcing element having a shape substantially corresponding to the shape of the deposition region; and depositing the annular reinforcing element at the deposition region. An apparatus for carrying out such a process is also described.

The present invention relates to a process for manufacturing tyres for vehicle wheels.

The invention also relates to an apparatus for the deposition of at least one reinforcing element on a toroidal support, said apparatus being able to be used to carry out the aforementioned process.

In the present description and in the subsequent claims, the term “reinforcing element” is used to indicate an element comprising one or more thread-like reinforcing elements, such as textile or metallic cords, incorporated in, or coated with, a layer of elastomeric material.

It should also be specified that, in the present description and in the subsequent claims, the term: elastomeric material, is used to indicate a composition comprising at least one elastomeric polymer and at least one reinforcing filler. Preferably, such a composition also comprises additives like, for example, a cross-linking agent and/or a plasticiser. Thanks to the provision of the cross-linking agent, such a material can be cross-linked through heating, so as to form the final product.

A tyre for vehicle wheels generally comprises a carcass structure comprising at least one carcass ply formed from reinforcing cords incorporated in an elastomeric matrix. The carcass ply has end edges respectively engaged with annular anchoring structures, arranged in the areas usually identified with the name “beads” and normally each formed from a substantially circumferential annular insert on which at least one filling insert is applied, in a radially outer position thereof. Such annular structures are commonly referred to as “beads cores” and have the task of keeping the tyre well fixed to the anchoring seat specifically provided in the rim of the wheel, thus avoiding in operation the radially inner end edge of the tyre coming out from such a seat.

At the beads specific reinforcing structures can be provided having the function of improving the torque transmission to the tyre. The region of the beads, indeed, is particularly active in the torque transmission from the rim to the tyre when accelerating and when braking and, therefore, the provision of appropriate reinforcing structures in this area ensures that the torque transmission occurs with the maximum possible reactivity.

In a radially outer position with respect to the carcass ply a belt structure comprising one or more belt layers is associated, said belt layers being arranged radially one on top of the another and having textile or metallic reinforcement cords with crossed orientation and/or substantially parallel to the direction of circumferential extension of the tyre.

Between the carcass structure and the belt structure a layer of elastomeric material can be provided, known as “under-belt”, having the function of making the radially outer surface of the carcass structure as uniform as possible for the subsequent application of the belt structure.

In a radially outer position with respect to the belt structure a tread band is applied, also made from elastomeric material like other structural elements making up the tyre.

Between the tread band and the belt structure a so-called “under-layer” of elastomeric material can be arranged, said layer having properties suitable to ensure a steady union of the tread band itself.

On the side surfaces of the carcass structure respective sidewalls of elastomeric material are also applied, each extending from one of the side edges of the tread band up to the respective annular anchoring structure to the beads.

Conventional manufacturing processes of tyres for vehicle wheels essentially provide for the components of the tyre listed above to be firstly made separately from each other, to then be assembled in a subsequent building step of the tyre.

Nevertheless the current tendency is that of using manufacturing processes that allow the production and storage of semi-finished products to be minimised, or possibly eliminated.

More specifically, attention has now turned towards process solutions that allow the individual components of the tyre to be made by directly applying them, according to a predetermined sequence, onto the tyre being built on a forming support, typically toroidal or cylindrical.

For example, in document WO 01/36185 to the same Applicant, the components of the tyre are made on a toroidal support by sequentially depositing a plurality of reinforcing elements thereon, the reinforcing elements consisting for example of individual rubberised cords or of rubberised cords grouped in parallel in the form of strip-like elements, particularly used in making the carcass and belt structure, and of continuous elongate elements in elastomeric material, particularly used for making the other structural components of the tyre, such as for example tread band, sidewalls, liners, fillers.

Document U.S. Pat. No. 6,355,126 describes for example a method and an apparatus for making a belt layer through deposition on a suitably positioned forming support of band-like pieces cut from a continuous band-like element. The band-like pieces, once cut from the continuous band-like element, are picked up through gripping means and moved to the forming support for deposition.

In EP 1 418 043 A2 a method and an apparatus for forming an annular elastomeric component of a tyre, in particular an insert for filling the beads, are described. The described method comprises an annular extrusion step of elastomeric material on a forming support and a modelling step, through the action of a modelling extruder on the surface of the forming support, of the material deposited to obtain the desired profile for the component.

In U.S. Pat. No. 6,379,493 B1 a device for the transportation and deposition onto a forming support of a tyre of cut to size pieces of elastomeric material is described, said pieces being in particular intended to form inserts for filling the beads. The device comprises rotatable gripping devices which are movable along a direction essentially tangential to the circumferential surface of the forming drum and allow each piece to be gripped and deposited in a predetermined position on the forming drum.

With particular reference to the region of the tyre defined at the bead, the Applicant has realised the importance of providing in this region a reinforcing structure, as described with reference to the tyre structure discussed above.

The Applicant has considered the problem of making and applying, on a substantially toroidal forming support, a reinforcing structure comprising one or more reinforcing element in the region of the bead of the tyre in a process for producing tyres for example of the type described in document WO 01/36185 previously mentioned.

The Applicant has verified the possibility of forming on a substantially toroidal forming support a reinforcing structure as described above by applying at least one reinforcing element on a substantially annular deposition region defined on said toroidal support, said deposition region for example being able to be defined at the region of the bead on a surface of the forming support that is not perfectly planar.

The Applicant has also verified the possibility of carrying out the aforementioned application while maintaining the maximum possible flexibility in terms of diameter and thickness of the reinforcing element and inclination of the thread-like reinforcing elements incorporated therein, ensuring high structural homogeneity along the direction of circumferential extension of the tyre and at the same time avoiding the formation of possible defects on the tyre, such as for example overlapping or undesired spaces in the reinforcing structure. This allows a deposition according to the design to be ensured and thus allows increasingly high quality and performance levels of the tyre to be ensured.

The Applicant has found that by depositing a reinforcing element deformed so that its shape substantially corresponds to the shape of the deposition region onto a toroidal forming support of a tyre, at a substantially annular deposition region, it is possible to obtain a tyre built substantially without defects in the region of the bead even with complex design geometries of the tyre itself.

The present invention therefore relates, in a first aspect thereof, to a process for manufacturing tyres for vehicle wheels, comprising building on a toroidal support a carcass structure comprising at least one carcass ply associated, at axially opposite end edges thereof, with annular anchoring structures;

wherein the step of building said carcass structure comprises forming at least one reinforcing structure, operatively associated with said annular anchoring structures through deposition on the toroidal support of at least one reinforcing element at a deposition region defined on the toroidal support;
wherein the step of depositing the at least one reinforcing element comprises the steps of:
providing at least one reinforcing element having a length determined as a function of the length of the deposition region;
deforming the at least one reinforcing element to form an annular reinforcing element having a shape substantially corresponding to the shape of the deposition region;
depositing the annular reinforcing element at the deposition region.

In the present description and in the subsequent claims, the expression “length of the deposition region” referred to a substantially annular deposition region indicates the length of the longitudinal development of such a region.

Advantageously, the process of the present invention, in a process for manufacturing tyres for example of the type described in document WO 01/36185, allows a reinforcing structure to be made that is substantially homogeneous and uniform, in particular circumferentially, at the bead region of the tyre. This is achieved by deforming the whole reinforcing element, previously provided with a length determined as a function of the length of the deposition region, so as to give it an annular shape substantially corresponding to that of the deposition region, and then depositing the deformed reinforcing element. Furthermore, this result is achieved substantially irrespective of the size of the deposition region, the width of the reinforcing element and the arrangement of thread-like reinforcing elements present inside the reinforcing element.

It is thus possible to make on a toroidal forming support a tyre reinforced at the bead region having high quality levels and, consequently, high performance.

In a preferred embodiment of the process of the invention, the step of providing the at least one reinforcing element comprises the steps of:
cutting to size a piece from a continuous reinforcing band-like element fed along a predetermined feeding direction;
approaching said piece to a previously cut piece along an approach direction inclined with respect to the feeding direction;
joining said piece to the previously cut piece;
repeating the cutting, approaching and joining steps until the at least one reinforcing element is given a length determined according to the length of the deposition region.

Advantageously, through the aforementioned steps it is possible to provide a reinforcing element having a desired inclination of the thread-like reinforcing elements within it and a desired length starting from a continuous reinforcing element comprising thread-like reinforcing elements oriented substantially parallel to the longitudinal extension thereof, as a continuous reinforcing element produced for example through drawing and/or calandering processes, known to the man skilled in the art, can be.

Preferably, in the aforementioned joining step a piece is joined to the previously cut piece at respective joining sides parallel to the feeding direction.

Preferably, the joining step comprises the step of partially overlapping the pieces at the respective joining sides.

Preferably, in the cutting step the piece is cut according to a cutting angle of between about 0° and about 70°.

More preferably, such a cutting angle is between about 20° and about 65°.

In alternative embodiments of the process of the invention, it is also possible for the aforementioned approaching and joining steps of the pieces, and possibly also the cutting to size step, to be left out, reinforcing elements being provided that have been previously prepared and are already suitable, as to their structure and possibly also to their length, for the subsequent deformation and deposition steps.

In a preferred embodiment of the process of the invention, the toroidal support has a rotation axis X-X and the step of deforming the at least one reinforcing element comprises the steps of:
forming said annular reinforcing element closing the at least one reinforcing element in a loop around the rotation axis X-X so as to generate a substantially cylindrical surface, said substantially cylindrical surface lying on a first laying surface having, in a predetermined point thereof, a normal extending along a first direction;
moving the substantially cylindrical surface from the first laying surface to a second laying surface having, in a point corresponding to said predetermined point on the first laying surface, a normal extending along a second direction inclined with respect to the first direction.

Advantageously, the deformation of the reinforcing element is thus achieved through a substantially geometric effect connected to the variation of the lying position of a reinforcing element, previously closed in a loop, as a whole. This type of deformation allows a high structural homogeneity to be obtained in the deformed reinforcing element, in particular as far as the final annular distribution of the reinforcing elements is concerned.

Preferably, the step of deforming the at least one reinforcing element further comprises, after the step of forming the annular reinforcing element and before the moving step, the step of changing the radial extension of the substantially cylindrical surface.

Preferably, the step of changing the radial extension of the substantially cylindrical surface comprises radially expanding such a substantially cylindrical surface.

Advantageously, through this step it is possible to adapt the annular reinforcing element to deposition regions having different diameters.

Preferably, on the first laying surface the substantially cylindrical surface is substantially coaxial with respect to the rotation axis X-X of the toroidal support.

Preferably, on the second laying surface the annular reinforcing element defines a substantially frusto-conical surface having a longitudinal axis coinciding with the longitudinal axis of the substantially cylindrical surface.

These characteristics advantageously allow a deformed annular reinforcing element to be obtained in a simple and accurate manner, said annular reinforcing element being ready to be deposited at a non-planar substantially annular deposition region, like that at the bead region of a tyre.

Preferably, the deposition step is carried out during the moving step.

This advantageously allows the overall time taken to carry out the deposition process to be reduced.

In a preferred embodiment of the process of the invention, it is also provided the step of passing a pressing member on the deposited annular reinforcing element.

Advantageously, this further step ensures that the deposited annular reinforcing element adheres perfectly and along the entire surface thereof to the underlying structures of the tyre being built.

Preferably, the deposition region is a substantially circular annular region with an inner radius of between about 200 mm and about 350 mm.

Preferably, the at least one reinforcing element has a width of between about 10 mm and about 50 mm.

Preferably, the at least one reinforcing element comprises at least one thread-like reinforcing element incorporated in an elastomeric material.

Preferably, at the end of the deposition step the at least one thread-like reinforcing element is orientated so as to form an angle greater than or equal to 0° and less than 90° with a radial direction passing through its own radially inner end.

In a second aspect thereof, the present invention refers to an apparatus for depositing on a toroidal support a reinforcing element of a tyre for vehicle wheels, comprising:
at least one device for feeding a reinforcing element;
at least one deposition device suitable for forming an annular reinforcing element and for depositing said annular reinforcing element at a deposition region defined on the toroidal support;
   wherein the at least one deposition device comprises a main body and at least one mobile element associated with the main body and actuatable to deform the annular reinforcing element so as to give it a shape substantially corresponding to the shape of the deposition region.

Such an apparatus can advantageously be used to carry out the process of the present invention described above.

In a preferred embodiment of the apparatus of the invention, the at least one feeding device feeds a continuous reinforcing band-like element along to a predetermined feeding direction.

In this case, the apparatus of the invention preferably comprises at least one cutting device for cutting to size pieces of the continuous reinforcing band-like element.

The apparatus of the invention also preferably comprises at least one assembling device suitable for receiving such pieces and for allowing them to be joined together to obtain said reinforcing element.

Advantageously, the at least one cutting device and the at least one assembling device can cooperate with the feeding device, in the case in which it feeds a continuous reinforcing element, to form a reinforcing element from which the annular reinforcing element to be subsequently deformed and deposited is obtained.

In alternative embodiments, it is nevertheless possible for the at least one assembling device, and possibly also the at least one cutting device, to be left out. In these cases the at least one feeding device feeds reinforcing elements that have been previously prepared and are already suitable, as to their structure and possibly also to their length, for forming the annular reinforcing element.

Preferably, the at least one assembling device comprises a conveyor belt movable along a conveying direction and suitable for sequentially receiving the aforementioned pieces.

Preferably, the feeding direction of the at least one feeding device forms a feeding angle of more than 0° and less than 180° with such a conveying direction.

More preferably, such a feeding angle is equal to about 90°−α, where α is the cutting angle of the pieces from the continuous reinforcing band-like element.

Advantageously, this relative position between the at least one feeding device and the at least one assembling device allows a desired structure to be given, in a substantially automatic manner and with high flexibility, to the reinforcing element to be deposited, in particular as far as the arrangement and orientation of thread-like reinforcing elements provided therein are concerned.

In a preferred embodiment thereof, the at least one deposition device comprises a disc-shaped element rotatable about a respective longitudinal axis and is provided with a plurality of rotatable elements which can rotate about respective pin axes arranged around said rotation axis, each of said rotatable elements comprising a seat for receiving a portion of the annular reinforcing element and being able to take up a first operative position, wherein the receiving seat extends, with reference to said longitudinal axis, along a first direction, and a second operative position, wherein the receiving seat extends, with reference to said longitudinal axis, along a second direction inclined with respect to the first direction.

Advantageously, the rotatable elements, through rotation thereof, allow the deformation of the reinforcing element loaded on the deposition device to be obtained, moving such an element from the first laying surface to the second laying surface, as described above with reference to the process of the present invention.

Preferably, each of said pin axes is arranged at an axially inner edge of said receiving seat.

Preferably, the rotatable elements are circumferentially arranged around the longitudinal axis of the disc-shaped element and are radially movable with respect to such a longitudinal axis.

Advantageously, it is thus possible to vary the radial position of the rotatable elements to radially deform the annular reinforcing element and adapt it to deposition regions having different diameters.

Preferably, the rotatable elements comprise respective electromagnets.

Such electromagnets help in keeping the reinforcing element in position during the deformation and deposition step in the case where such an element comprises steel thread-like reinforcing elements.

Preferably, the at least one deposition device is movable with respect to the toroidal support along a direction substantially coinciding with a rotation axis of said toroidal support.

Preferably, the apparatus of the invention further comprises a pressing member suitable for exerting a pressure on the annular reinforcing element deposited on said toroidal support.

In a preferred embodiment thereof, the apparatus of the invention comprises two feeding devices and two deposition devices provided for substantially simultaneously depositing two respective annular reinforcement elements at two deposition regions defined on axially opposite sides of the toroidal support.

Preferably, in this case, the apparatus also comprises two of the aforementioned cutting devices and two of the aforementioned assembling devices.

Further characteristics and advantages of the present invention shall become clearer from the following detailed description of a preferred embodiment of an apparatus and of a process according to the present invention, made hereafter with reference to the attached drawings. In such drawings:

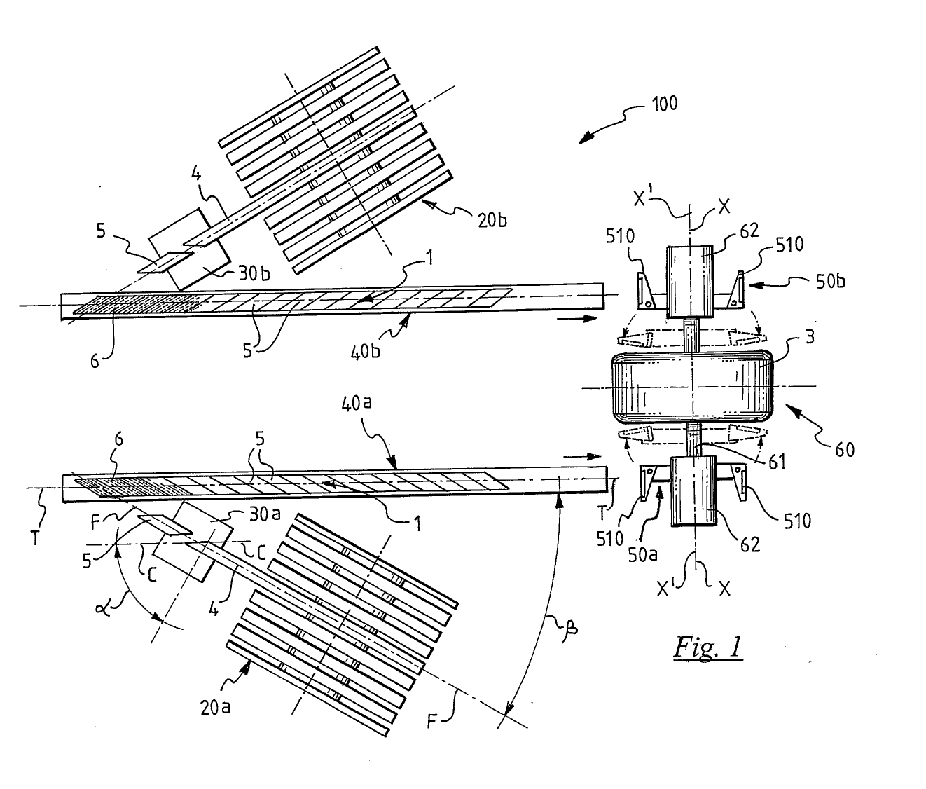

FIG. 1 is a schematic top view of a deposition apparatus according to the invention;

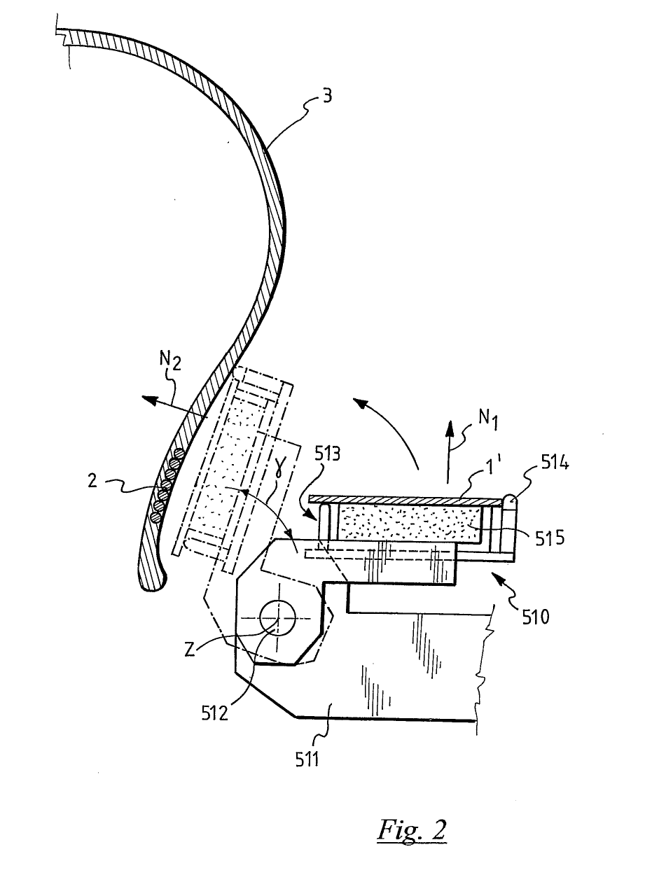

FIG. 2 is a partially sectional view in a generic radial plane of a tyre being built, that schematically shows a detail of a deposition device of the apparatus of FIG. 1 and action thereof according to the deposition process of the present invention;

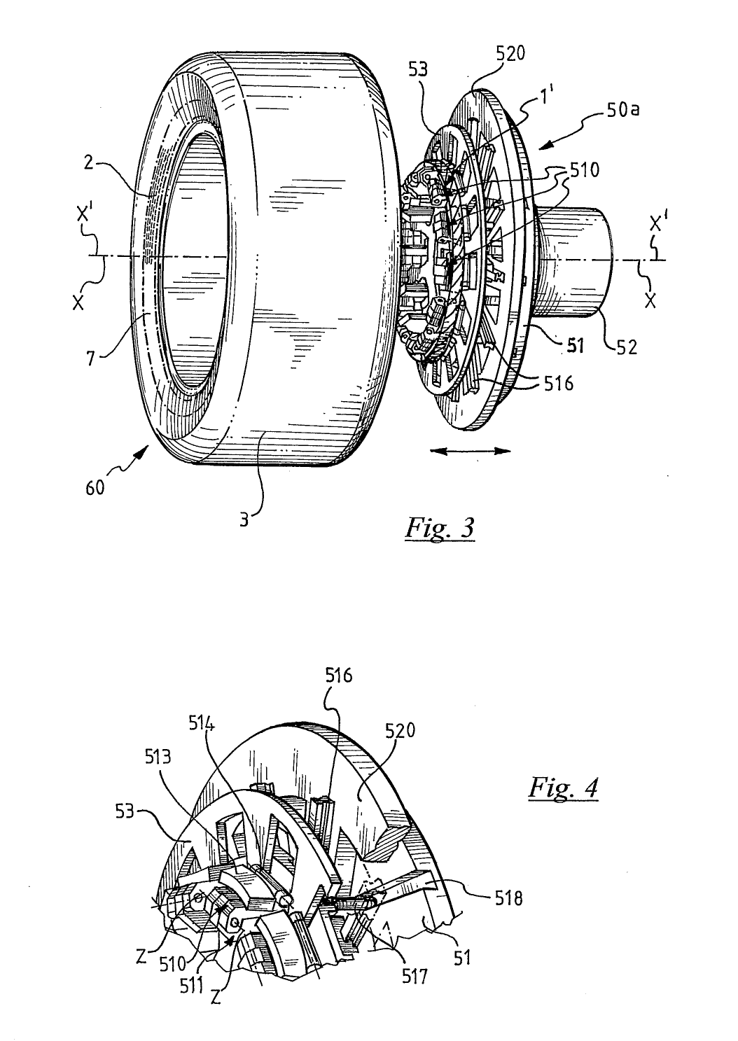

FIG. 3 is a schematic perspective view of the deposition device of the apparatus of FIG. 1 placed near to a toroidal forming support;

FIG. 4 is a schematic perspective view with partially removed parts of a detail of the deposition device of FIG. 3;

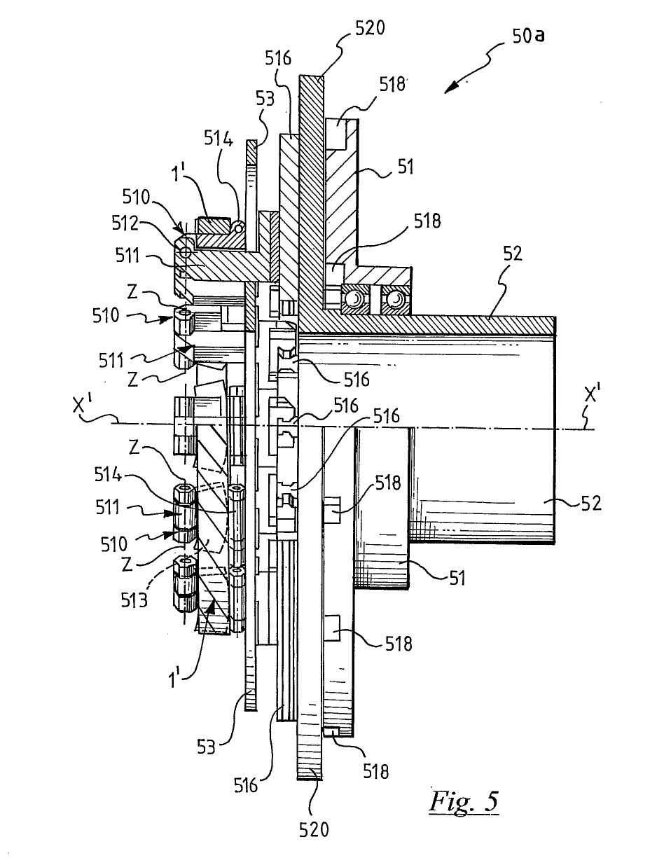

FIG. 5 is a schematic partially sectional side view of the deposition device of FIG. 3;

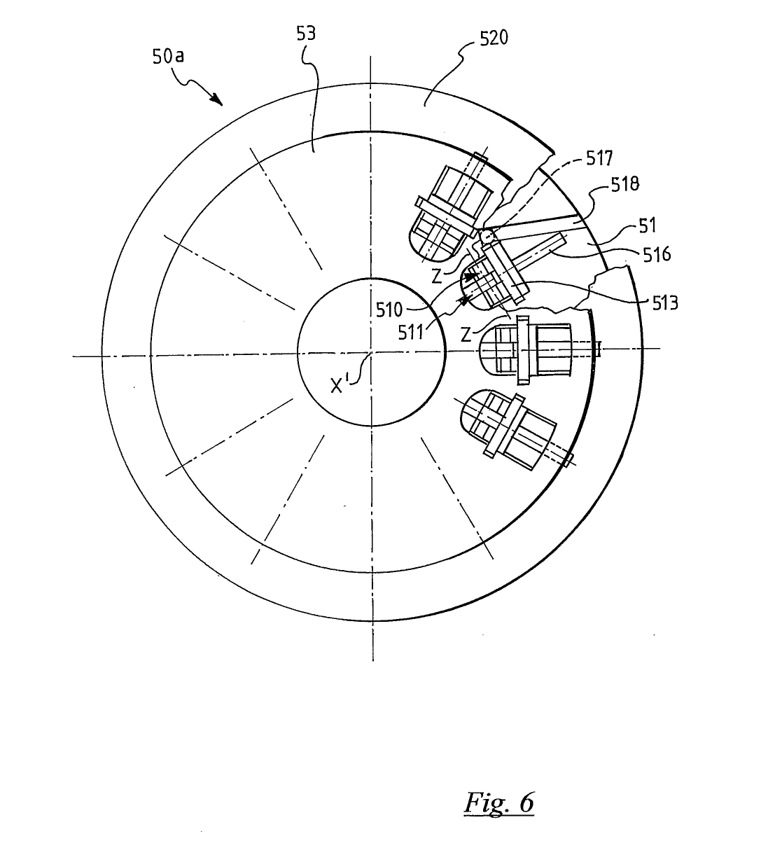

FIG. 6 is a schematic top view with partially removed parts of the deposition device of FIG. 3.

In FIG. 1, an exemplary embodiment of an apparatus for depositing reinforcing elements of vehicle tyres according to the present invention is wholly indicated with reference numeral 100.

The apparatus 100 can, for example, be part of a work station of the type described in document WO 01/36185 to the same Applicant.

In the exemplary embodiment described, the apparatus 100 is suitable for making a reinforcing structure, operatively associated with annular anchoring structures 2 (only one of which is illustrated in FIGS. 2 and 3) of a carcass structure 3 in the bead region of a tyre. The reinforcing structure comprises at least one annular reinforcing element 1′ formed and deposited as described hereafter. The specific axial position of each annular reinforcing element 1′ with respect to the annular anchoring structures 2 can vary according to product the requirements of the; for example, the reinforcing structure can comprise a single annular reinforcing element 1′ between two layers of annular anchoring structures 2, or else in axially outer position with respect to the annular anchoring structures 2. It is also possible to provide a reinforcing structure comprising many annular reinforcing elements 1′ operatively associated, at different axial positions, with the annular anchoring structures 2.

The manufacturing of the reinforcing structure, as well as of the other components and structures of the tyre being built, is advantageously carried out on a toroidal support 60, having an outer surface configured substantially according to the inner configuration of the tyre to be made and not described here in detail, since it can be made in any convenient way by the man skilled in the art. During the manufacture of the reinforcing structure the toroidal support 60 preferably rests, through a support shaft 61 coaxial to a rotation axis X-X, on suitable fixed supports 62.

A reinforcing element 1 is preferably formed from pieces 5 of predetermined length, obtained through cutting operations sequentially carried out on at least one continuous reinforcing band-like element 4, and then suitably joined. From the reinforcing element 1 an annular reinforcing element 1′ is then formed, which is then deposited at a predetermined substantially annular deposition region 7 defined on the toroidal support 60 (FIG. 3), as shall be described in detail hereafter, with reference to a preferred embodiment of the process of the invention.

In alternative embodiments, not described in detail here, a reinforcing element 1 ready for use can be provided, having the desired structure and length. In this case the apparatus 100 may not comprise devices specifically intended for the formation of the reinforcing element 1 from a continuous band-like element 4, as described later on, just as the process of the invention may not provide specific steps intended for the formation of the reinforcing element 1, by this meaning that such an element has been separately provided upstream of the deposition process, according to ways known to those skilled in the art.

The continuous band-like element 4 and, consequently, the pieces 5 and the reinforcing element 1 obtained from it, preferably comprise a plurality of thread-like reinforcing elements 6 (for the sake of clarity shown only in FIG. 1) made from metallic or textile material incorporated in a matrix of elastomeric material. Within the continuous band-like element 4 such thread-like reinforcing elements 6 extend parallel to each other, substantially along the direction of longitudinal extension of the continuous band-like element 4, whereas within the reinforcing element 1 the thread-like reinforcing elements 6 extend substantially parallel to each other, but obliquely with respect to the direction of longitudinal extension of the latter (FIG. 1), with an inclination determined by the specific ways of cutting and joining the pieces 5. In the present description and in the subsequent claims, the expression “direction of longitudinal extension” of the continuous band-like element 4 or of the reinforcing element 1 is used to indicate the line defining the longitudinal direction of such elements and passing through the middle point of one of the two shorter end sides.

The width of the reinforcing element 1 is preferably between about 10 mm and about 50 mm, wherein about 25 mm is a particularly preferred operative value.

As schematically represented in FIG. 1, the apparatus 100 comprises two feeding devices 20a, 20b suitable for feeding respective continuous band-like elements 4, two cutting devices 30a, 30b suitable for carrying out cutting to size operations on the continuous band-like elements 4 to make the pieces 5, two assembling devices 40a, 40b suitable for receiving the pieces 5 and for allowing them to be joined together to form respective reinforcing elements 1, and two deposition devices 50a, 50b suitable for receiving such reinforcing elements 1 and for depositing them on the toroidal support 60.

The pairs of feeding devices 20a, 20b, cutting devices 30a, 30b, assembling devices 40a, 40b and deposition devices 50a, 50b are identical to each other and are spatially arranged with respect to the toroidal support 60 so as to allow the formation and substantially simultaneous deposition of annular reinforcing elements 1′ at both of the axially opposite bead regions of the tyre being built.

In the following description reference shall be made in particular to a one device for each of the aforementioned pairs, meaning that what said is also valid for the other, unless specifically indicated otherwise.

The feeding device 20a can be a feeding reel, as shown in FIG. 1, or another equivalent device known to those skilled in the art, such as a drawing and/or calandering device. The feeding device 20a feeds the continuous band-like element 4 according to a feeding direction F.

The assembling device 40a preferably comprises a conveyor belt movable along a conveying direction T towards the deposition device 50a. This conveyor belt sequentially receives the pieces 5 cut through the cutting device 30a so that they are arranged on it in a side-by-side relationship, so as to be able to make joins along sides parallel to the feeding direction F, in this way forming reinforcing elements 1 of predetermined length.

According to the invention, the deposition device 50a, as well as for receiving the reinforcing elements 1, is suitable for deforming such elements into annular reinforcing elements 1′ before deposition, to adapt them to the shape of the deposition region 7.

As shown in particular in FIGS. 3 and 5, the deposition device 50a comprises a main body essentially consisting of a disc-shaped element 51 rotatably associated with a substantially cylindrical support element 52 provided, at a free end thereof on which the disc-shaped element 51 is mounted, with a flange 520. The disc-shaped element 51 and the support element 52 are coaxial with respect to a longitudinal axis X′-X′.

A plurality of rotatable elements 510 is associated with the disc-shaped element 51 through respective support groups 511, which extend vertically in a substantially axial direction from a face of such a disc-shaped element 51. The rotatable elements 510 are associated with the support groups 511 through pins 512, which define pin axes Z-Z about which the rotation of the rotatable elements 510 can take place. The support groups 511 and the pin axes Z-Z are arranged substantially circumferentially around the longitudinal axis X′-X′.

Each rotatable element 510 comprises a respective receiving seat 513 suitable for receiving a portion of the reinforcing element 1, which, once loaded on the deposition device 50a, defines an annular reinforcing element 1′. The pin axes Z-Z extend at the axially inner edge of each receiving seat 513, whereas at the axially outer edge an abutment 514 is preferably formed for the annular reinforcing element 1′. In the present description and in the subsequent claims, the expressions “axially inner” and “axially outer” relative to components or parts of the deposition device 50a refer to the operative position of the deposition device 50a in the proximity of the toroidal support 60 upon deposition (FIGS. 2 and 3).

Each rotatable element 510 comprises, at the receiving seat 513, an electromagnet 515, which in particular helps in keeping the annular reinforcing element 1′ in position during the deformation and deposition steps, in the case where it comprises steel thread-like reinforcing elements 6.

As can be seen in particular in FIG. 2, each of the rotatable elements 510 can rotate about the respective pin axis Z-Z between a first operative position and a second operative position, determining through such a movement the deformation of the annular reinforcing element 1′, as shall be described more clearly hereafter with reference to a preferred embodiment of the process of the invention. In particular, in the first operative position, corresponding to a rest configuration of the rotatable elements 510, the receiving seats 513 extend, with reference to the longitudinal axis X′-X′, along a first direction, preferably substantially parallel to such an axis, whereas in the second operative position, corresponding to a rotated configuration, the receiving seats 513 extend, again with reference to said longitudinal axis X′-X′, along a second direction inclined with respect to the first direction.

The support groups 511, and therefore the rotatable elements 510, are also radially movable with respect to the disc-shaped element 51, to allow a radial deformation of the annular reinforcing element 1′. The radial movement of the support groups 511 is achieved through a suitable displacing mechanism, which, in the embodiment described here, can be operated through rotation (FIGS. 4, 5 and 6). Such a displacing mechanism comprises small shafts 517 extending parallel to the longitudinal axis X′-X′ from each support group 511 and free to slide in respective grooves 518 formed on a face of the disc-shaped element 51. The grooves 518 extend from the centre towards the periphery of the disc-shaped element 51 inclined by a predetermined angle with respect to the radial direction. In this way, a lateral thrust given to each support group 511 through the rotation of an actuation disc 53 operatively associated with the support groups 511 can determine a movement in the radial direction of such support groups 511 with respect to the disc-shaped element 51. The correct radial alignment of each support group 511 during movement is ensured by radial guides 516, which are fixed to the disc-shaped element 51 at radially inner ends thereof and rest upon the flange 520. The radial movement of the support groups 511 and therefore of the rotatable elements 510 allows the diameter of the annular reinforcing element 1′ for deposition on the toroidal support 60 to be varied.

The deposition device 50a is globally movable towards and away from the toroidal support 60 along a direction substantially coinciding with the rotation axis X-X thereof, as shown in FIGS. 1 and 3.

The deposition apparatus 100 preferably also comprises a conventional pressing member (not shown in the figures) known to the man skilled in the art, which can act upon the annular reinforcing element 1′ once deposited, so as to ensure the complete adherence thereof to the underlying structures of the tyre being built.

With reference to FIGS. 1, 2 and 3 a preferred embodiment of the deposition process of the invention that can be carried out through the deposition apparatus 100 described above shall now be described.

As stated above, through the preferred embodiment of the deposition apparatus 100 it is possible to simultaneously deposit two annular reinforcing elements 1′ at respective substantially annular deposition regions 7 at the axially opposite bead regions of the tyre being built. Also in the description of the preferred embodiment of the process of the invention, for the sake of simplicity, reference shall be made to the deposition of the annular reinforcing element 1′ on one of the two deposition regions 7, being understood that the steps described hereafter can be carried out simultaneously for deposition on the other deposition region 7 as well.

The deposition region 7 is substantially circular in shape, with the centre lying on the rotation axis X-X of the toroidal support 60 and the inner radius preferably between about 200 mm and about 350 mm.

In a first step of the process a reinforcing element 1 of predetermined length, determined as a function of the length of the deposition region 7, is provided. In the preferred embodiment described here, this is obtained by cutting to size pieces 5 from the continuous band-like element 4 and then suitably joining such pieces.

The continuous band-like element 4 is fed by the feeding device 20a′ according to the feeding direction F, substantially coinciding with the direction of longitudinal extension of the continuous band-like element 4, defined above. Each piece 5 is cut according to a cutting angle α of between about 0° and about 70°, more preferably between about 20° and about 65°, said cutting angle α being defined between the perpendicular to the direction of longitudinal extension and a cutting direction C.

The successively cut pieces 5 are then sequentially received by the assembling device 40a, having the form of a conveyor belt moving along the conveying direction T. The conveying direction T, which defines the direction along which the pieces 5 are arranged on the conveyor belt in side-by-side relationship, is inclined with respect to the feeding direction F. In particular, the feeding direction F forms a feeding angle β of more than 0° and less than 180° with the conveying direction T. Preferably, the feeding angle β is linked to the cutting angle α by the relationship β=90°−α. Typically, the cutting angle α and the feeding angle β are preset and remain constant during the entire deposition process.

At the same time as the deposition on the assembling device 40a, each piece 5 is joined to the previously deposited piece 5. The joining is carried out at adjacent sides parallel to the feeding direction F of adjacent pieces 5 and provides for partial overlapping of such sides, preferably limited to an edge portion consisting of just elastomeric material, i.e. wherein no thread-like reinforcing elements are present. Alternatively, the pieces 5 can also be joined end to end.

The cutting, approaching and joining steps of the pieces 5 are repeated a predetermined number of times, until the reinforcing, element 1 is given the desired length.

In a subsequent step of the process, the reinforcing element 1 thus obtained is deformed so as to obtain the annular reinforcing element 1′ with a shape substantially corresponding to the shape of the deposition region 7.

In particular, firstly the reinforcing element 1 is closed in a loop coaxially around the rotation axis X-X of the toroidal support 60—i.e. around the longitudinal axis X′-X′ of the deposition device 50a, substantially coinciding with the rotation axis X-X—, so as to form a substantially cylindrical surface defining the annular reinforcing element 1′. This is in practice carried out by winding the reinforcing element 1 onto the deposition device 50a at the receiving seats 513 of the rotatable elements 510, and by joining the end portions of the reinforcing element 1′. The group of receiving seats 513 defines a first laying surface of the annular reinforcing element 1′ having, in a predetermined point, a normal N₁ extending along a first direction (FIG. 2). Considering that, as described above, in the operative rest position of the rotatable elements 510, the receiving seats 513 extend substantially parallel to the longitudinal axis X′-X′, the direction of the normal N₁ is substantially perpendicular to this axis.

After the formation of the annular reinforcing element 1′, the deformation step can comprise a radial expansion step of the annular reinforcing element 1′, carried out through the radial displacement of the support groups 511 of the rotatable elements 510, as described above.

Then, the deformation step provides for the movement of the annular reinforcing element 1′, possibly radially expanded, from said first laying surface to a second laying surface having, in a point corresponding to the aforementioned predetermined point on the first laying surface, a normal N₂ (FIG. 2) extending along a direction inclined with respect to the direction of the normal N₁. This is in practice carried out by moving the rotatable elements 510 from their operative rest configuration to the operative rotated configuration, wherein they define the second laying surface. In particular, the rotatable elements 510 are made to rotate about the respective pin axes Z-Z by an rotation angle γ preferably between about 35° and about 80°.

Passing from the first to the second laying surface the annular reinforcing element 1′ is deformed by a geometric effect, thus forming a substantially frusto-conical surface coaxial with respect to the axes X′-X′ ed X-X.

In a subsequent step of the process, the annular reinforcing element 1′ deformed as described, is deposited at the deposition region 7.

The deposition is preferably carried out at the end of the moving step of the annular reinforcing element 1′, having positioned the deposition device 50a at a distance from the toroidal support 60 such that the rotatable elements 510 at the end of their rotation come into abutment against the toroidal support 60, so as to obtain an at least partial adherence of the annular reinforcing element 1′ to the underlying structures.

In order to ensure complete adherence, a step of passing a pressing member (not shown) on the deposited annular reinforcing element 1′ is also provided.

1-32. (canceled)

33. A process for manufacturing tyres for vehicle wheels, comprising building, on a toroidal support, a carcass structure comprising at least one carcass ply associated, at axially opposite end edges thereof, with annular anchoring structures,
wherein building said carcass structure comprises forming at least one reinforcing structure, operatively associated with said annular anchoring structures through deposition on said toroidal support of at least one reinforcing element at a deposition region defined on said toroidal support, and
wherein the deposition of said at least one reinforcing element comprises the steps of:
providing at least one reinforcing element having a length determined as a function of a length of said deposition region;
deforming said at least one reinforcing element to form an annular reinforcing element having a shape substantially corresponding to the shape of said deposition region; and
depositing the annular reinforcing element at said deposition region.

34. The process according to claim 33, wherein providing said at least one reinforcing element comprises the steps of:
cutting to size a piece from a continuous reinforcing band-like element fed along a predetermined feeding direction;
approaching said piece to a previously cut piece along an approach direction inclined with respect to said feeding direction;
joining said piece to a previously cut piece;
repeating said cutting, approaching and joining steps until said at least one reinforcing element is given a length determined as a function of the length of said deposition region.

35. The process according to claim 34, wherein, in said joining step, said piece is joined to the previously cut piece at respective joining sides parallel to said feeding direction.

36. The process according to claim 35, wherein said joining step comprises partially overlapping pieces at said respective joining sides.

37. The process according to claim 34, wherein, in said cutting step, said piece is cut according to a cutting angle of between about 0° and about 70°.

38. The process according to claim 37, wherein said cutting angle is between about 20° and about 65°.

39. The process according to claim 33, wherein said toroidal support has a rotation axis, and the deforming step of said at least one reinforcing element comprises the steps of:
forming said annular reinforcing element by closing said at least one reinforcing element in a loop around said rotation axis so as to generate a substantially cylindrical surface, said substantially cylindrical surface lying on a first laying surface having, in a predetermined point thereof, a normal extending along a first direction; and
moving said substantially cylindrical surface from said first laying surface to a second laying surface having, in a point corresponding to said predetermined point on said first laying surface, a normal extending along a second direction inclined with respect to said first direction.

40. The process according to claim 39, wherein the deforming step of said at least one reinforcing element further comprises, after said step of forming said annular reinforcing element and before said moving step, the step of changing a radial extension of said substantially cylindrical surface.

41. The process according to claim 40, wherein said step of changing the radial extension of said substantially cylindrical surface comprises radially expanding said substantially cylindrical surface.

42. The process according to claim 39, wherein, on said first laying surface said substantially cylindrical surface is substantially coaxial with respect to said rotation axis.

43. The process according to claim 42, wherein on said second laying surface said annular reinforcing element defines a substantially frusto-conical surface having a longitudinal axis coinciding with a longitudinal axis of said substantially cylindrical surface.

44. The process according to claim 39, wherein said depositing step is carried out during said moving step.

45. The process according to claim 33, further comprising the step of passing a pressing member on a deposited annular reinforcing element.

46. The process according to claim 33, wherein said deposition region is a substantially circular annular region with an inner radius of between about 200 mm and about 350 mm.

47. The process according to claim 33, wherein said at least one reinforcing element has a width of between about 10 mm and about 50 mm.

48. The process according to claim 33, wherein said at least one reinforcing element comprises at least one thread-like reinforcing element incorporated in an elastomeric material.

49. The process according to claim 48, wherein, at the end of said depositing step, said at least one thread-like reinforcing element is oriented so as to form an angle greater than or equal to 0° and less than 90° with a radial direction passing through a radially inner end of said at least one thread-like reinforcing element.

50. An apparatus for depositing a reinforcing element of a tyre for vehicle wheels on a toroidal support, comprising:
at least one feeding device of a reinforcing element; and
at least one deposition device suitable for forming an annular reinforcing element and for depositing said annular reinforcing element at a deposition region defined on said toroidal support, wherein said at least one deposition device comprises a main body and at least one rotatable element associated with said main body and actuatable to deform said annular reinforcing element so as to provide a shape thereof substantially corresponding to a shape of said deposition region.

51. The apparatus according to claim 50, wherein said at least one feeding device feeds a continuous reinforcing band-like element along a predetermined feeding direction.

52. The apparatus according to claim 51, comprising at least one cutting device for cutting to size, pieces of said continuous reinforcing band-like element.

53. The apparatus according to claim 52, comprising at least one assembling device suitable for receiving said pieces and for allowing them to be joined together to obtain said reinforcing element.

54. The apparatus according to claim 53, wherein said at least one assembling device comprises a conveyor belt movable along a conveying direction and capable of sequentially receiving said pieces.

55. The apparatus according to claim 54, wherein said feeding direction forms a feeding angle of more than 0° and less than 180° with said conveying direction.

56. The apparatus according to claim 55, wherein said feeding angle is equal to about 90°−α, where α is a cutting angle of said pieces from said continuous reinforcing band-like element.

57. The apparatus according to claim 50, wherein said at least one deposition device comprises a disc-shaped element rotatable about a longitudinal axis and provided with a plurality of rotatable elements which can rotate about respective pin axes arranged around said longitudinal axis, each of said at least one rotatable element comprising a receiving seat of a portion of said annular reinforcing element and capable of taking up a first operative position, wherein said receiving seat extends, with reference to said longitudinal axis, along a first direction, and a second operative position, wherein said receiving seat extends, with reference to said longitudinal axis, along a second direction inclined with respect to said first direction.

58. The apparatus according to claim 57, wherein each of said pin axes is arranged at an axially inner edge of said receiving seat.

59. The apparatus according to claim 57, wherein said rotatable elements are circumferentially arranged around the longitudinal axis of said main body and are radially movable with respect to said longitudinal axis.

60. The apparatus according to claim 57, wherein said rotatable elements comprise respective electromagnets.

61. The apparatus according to claim 50, wherein said at least one deposition device is movable with respect to said toroidal support along a direction substantially coinciding with a rotation axis of said toroidal support.

62. The apparatus according to claim 50, further comprising a pressing member suitable for exerting a pressure on an annular reinforcing element deposited on said toroidal support.

63. The apparatus according to claim 50, comprising two feeding devices and two deposition devices provided for substantially simultaneously depositing two respective annular reinforcing elements at two deposition regions defined on axially opposite sides of said toroidal support.

64. The apparatus according to claim 63, comprising two cutting devices and two assembling devices when said at least one feeding device feeds a continuous reinforcing band-like element along a predetermined feeding direction.
